(19) United States
(12) Patent Application Publication
(10) Pub. No.: US 2021/0069042 A1
(43) Pub. Date: Mar. 11, 2021

(54) MOTORIZED BATH SEAT

(71) Applicants: Patricia Devandry, Dickson, TN (US); Henry Dean Milby, Dickson, TN (US)

(72) Inventors: Patricia Devandry, Dickson, TN (US); Henry Dean Milby, Dickson, TN (US)

(21) Appl. No.: 16/568,024

(22) Filed: Sep. 11, 2019

(51) Int. Cl. A61G 7/10

(52) U.S. Cl. CPC A61G 7/1003; A61G 7/1019; A61G 7/1076; A61G 7/1092; A61G 7/1088; A61G 7/1059

(57) ABSTRACT

An illustrated view of an exemplary motorized bath seat apparatus for assisting bathers getting in and out of a bathtub is presented. The motorized bath seat apparatus is useful for assisting an individual into safely and conveniently lower the individual or bather into the bathtub without human assistance. The motorized bath seat apparatus further allows a disabled, post-surgical patient, elderly, etc. more easily bathe without assistance of a caregiver therefore giving the bather privacy and self-value. The apparatus has two rails coupled to motor. The motor powers a bracket that is coupled to the rail and is hingedly attached such that the seat can be moved to allow a person to move a seat apparatus over the bath tube then utilize an actuator to lower and raise the seat assembly. The seat assembly is coupled to a bracket. The seat assembly has a seat coupled to a bottom of a first right arm rest and to a bottom of a second arm rest. The bracket is coupled to a seat back that is coupled to the right arm rest and coupled to the left arm rest.

### FIELD OF THE INVENTION

This invention relates to baths. More particularly, it relates to seats for the bath.

### BACKGROUND

A bathtub, bath, or tub is a large or small container for holding water in which a person or animal may bathe. Most modern bathtubs are made of thermoformed acrylic, porcelain enameled steel, fiberglass-reinforced polyester, or porcelain enameled cast iron. A bathtub is usually placed in a bathroom either as a stand-alone fixture or in conjunction with a shower.

Modern bathtubs have overflow and waste drains and may have taps mounted on them. They are usually built-in, but may be free-standing or sometimes sunken. Until recently, most bathtubs were roughly rectangular in shape, but with the advent of acrylic thermoformed baths, more shapes are becoming available. Bathtubs are commonly white in color, although many other colors can be found.

Getting in and out of the bathtub or shower may be a risky and potentially dangerous task for many older adults, even if they have bathrooms equipped with safety features. Often, elderly or others afflicted with disease or other ailment are either too weak to get into the bathtub themselves or are unable to maneuver their body over a wall of the bathtub.

In light of the foregoing, there is a need for an apparatus that can assist those unable to get into or out of a bathtub without compromising the condition of the bather.

### BRIEF DESCRIPTION OF THE DRAWINGS

FIG. 1 is an illustrated view of an exemplary motorized bath seat apparatus.

### DETAILED DESCRIPTION

The phrases “in one embodiment,” “in various embodiments,” “in some embodiments,” and the like are used repeatedly. Such phrases do not necessarily refer to the same embodiment. The terms “comprising,” “having,” and “including” are synonymous, unless the context dictates otherwise. Such terms do not generally signify a closed list.

“Above,” “adhesive,” “affixing,” “any,” “around,” “both,” “bottom,” “by,” “comprising,” “consistent,” “customized,” “enclosing,” “friction,” “in,” “labeled,” “lower,” “magnetic,” “marked,” “new,” “nominal,” “not,” “of,” “other,” “outside,” “outwardly,” “particular,” “permanently,” “preventing,” “raised,” “respectively,” “reversibly,” “round,” “square,” “substantial,” “supporting,” “surrounded,” “surrounding,” “threaded,” “to,” “top,” “using,” “wherein,” “with,” or other such descriptors herein are used in their normal yes-or-no sense, not as terms of degree, unless context dictates otherwise.

Reference is now made in detail to the description of the embodiments as illustrated in the drawings. While embodiments are described in connection with the drawings and related descriptions, there is no intent to limit the scope to the embodiments disclosed herein. On the contrary, the intent is to cover all alternatives, modifications and equivalents. In alternate embodiments, additional devices, or combinations of illustrated devices, may be added to, or combined, without limiting the scope to the embodiments disclosed herein.

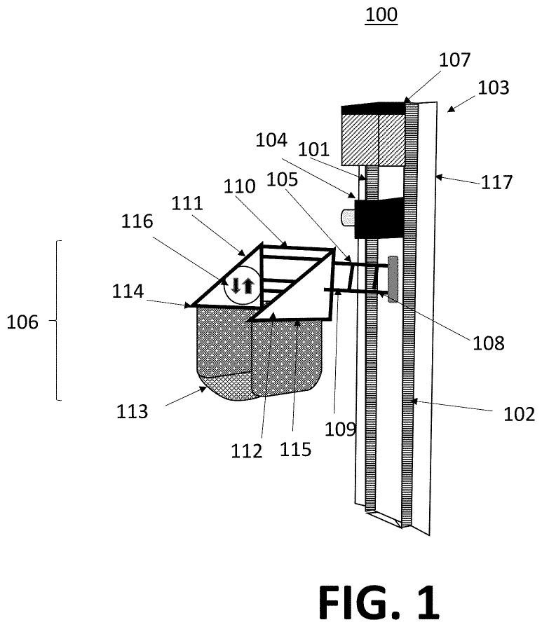

Referring to FIG. 1, an illustrated view of an exemplary motorized bath seat apparatus 100 for assisting bathers getting in and out of a bathtub is presented. The motorized bath seat apparatus 100 is useful for assisting an individual into safely and conveniently lower the individual or bather into the bathtub without human assistance. The motorized bath seat apparatus 100 further allows a disabled, post-surgical patient, elderly, etc. more easily bathe without assistance of a caregiver therefore giving the bather privacy and self-value.

The motorized bath seat apparatus 100 has a first rail 101, a second rail 102, a back 103, a motor 104, a bracket 105 and a seat assembly 106. The motorized bath seat apparatus is preferably six (6) feet in height, however other heights are hereby contemplated, including, but not limited to, four (4) feet, eight (8) feet, etc.

The first rail 101 and the second rail 102 of the motorized bath seat apparatus 100 are identical. The first rail 101 and the second rail 102 of the motorized bath 102 are coupled to a top rail 107. The back 103 of the motorized bath seat 100 is coupled to a surface 117, such as a wall, by a coupling (not shown). The coupling is preferably a screw device, however other devices are hereby contemplated, including, but not limited to, nails, adhesive, lag bolts, etc. The first rail 101 of the motorized bath seat 100 is preferably an aluminum material, however other materials are hereby contemplated, including, but not limited to, steel, poly-vinyl chloride (PVC), etc. The second rail 102 of the motorized bath seat 100 is preferably an aluminum material, however other materials are hereby contemplated, including, but not limited to, steel, poly-vinyl chloride (PVC), etc.

The motor 104 is communicatively coupled to the first rail 101 of the motorized bath seat 100 and the motor 104 is coupled to the second rail 102 of the motorized bath seat. The motor 104 has a power source (not shown). The power source for the motor 104 is preferably AC/DC, however other sources of power are hereby contemplated, including, but not limited to, solar energy, rechargeable battery, disposable battery, etc.

The bracket 105 has a first end 108 and a second end 109. The first end 108 of the bracket 105 is hingedly coupled to the first rail 101 of the motorized bath seat 100. The second end 109 of the bracket 105 is coupled to the seat assembly 106. The bracket 105 is preferably made of a metal material, such as aluminum, steel, titanium, etc. however other materials are hereby contemplated, including, but not limited to, poly-vinyl chloride (PVC), hard-plastic, etc.

The seat assembly 106 has a back rest 110, a right arm rest 111, a left arm rest 112 and a seat 113. The back rest 110 is coupled to the right arm rest 111 and coupled to the left arm rest 112. The seat 113 is coupled to a bottom 114 of the right arm rest 111 and coupled to a bottom 115 of the left arm rest 112. The seat 113 is preferably made of a nylon material, however other materials are hereby contemplated, including, but not limited to, hard-plastic, PVC, vinyl, etc.

The right arm rest 111 of the seat assembly 106 has an actuator 116. The actuator 116 is configured to raise the seat assembly 106 in an upward direction and/or to lower the seat assembly 106 in a downward direction. The actuator 116 is preferably a button, however other types of actuators are hereby contemplated, including, but not limited to, toggle switch, touch screen, etc.

In the numbered clauses below, specific combinations of aspects and embodiments are articulated in a shorthand form such that (1) according to respective embodiments, for each instance in which a “component” or other such identifiers appear to be introduced (with “a” or “an,” e.g.) more than once in a given chain of clauses, such designations may either identify the same entity or distinct entities; and (2) what might be called “dependent” clauses below may or may not incorporate, in respective embodiments, the features of “independent” clauses to which they refer or other features described above.

Those skilled in the art will appreciate that the foregoing specific exemplary processes and/or devices and/or technologies are representative of more general processes and/or devices and/or technologies taught elsewhere herein, such as in the claims filed herewith and/or elsewhere in the present application.

The features described with respect to one embodiment may be applied to other embodiments or combined with or interchanged with the features of other embodiments, as appropriate, without departing from the scope of the present invention.

Other embodiments of the invention will be apparent to those skilled in the art from consideration of the specification and practice of the invention disclosed herein. It is intended that the specification and examples be considered as exemplary only, with a true scope and spirit of the invention being indicated by the following claims.

What is claimed is:

1. A motorized bath seat apparatus for moving a bather into and out of a bathtub, the apparatus comprising:
a first rail and a second rail, the first rail and the second rail being securely coupled to a surface;
a motor, the motor being coupled to the first rail, wherein the motor further being coupled to the second rail;
a bracket, the bracket having a first end and a second end, wherein the first end of the bracket being hingedly coupled first rail; and
a seat assembly, the seat assembly comprising:
a right arm rest;
a left arm rest,
a seat back, the seat back being coupled to the right arm rest, wherein the seat back being coupled to the left arm rest, and wherein the seat back being hingedly coupled to a second end of a bracket;
an actuator, the actuator coupled to the right arm rest, wherein the actuator for raising and lowering the seat assembly; and
a seat, the seat being coupled to a bottom of the right arm rest, and wherein the seat being coupled to a bottom of the left arm rest.

2. The apparatus of claim 1, wherein the actuator being a button.

3. The apparatus of claim 1, wherein the first rail being made of an aluminum material.

4. The apparatus of claim 1, wherein the second rail being made of an aluminum material.

5. The apparatus of claim 1, wherein the seat being made of a nylon material.

6. The apparatus of claim 1, wherein the bracket being made of a metal material.

7. The apparatus of claim 6, wherein the metal material being aluminum.

8. The apparatus of claim 1, wherein the motor being coupled to a power supply.

9. The apparatus of claim 8, wherein the power supply being AC/DC.
